(19) United States
(12) Patent Application Publication
(10) Pub. No.: US 2005/0034972 A1
(43) Pub. Date: Feb. 17, 2005

(54) Apparatus and method for treating chemical substances in a microwave field

(76) Inventor: Werner Lautenschlager, Leutkirch (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/621,542

(22) Filed: Jul. 17, 2003

(30) Foreign Application Priority Data
Apr. 4, 2003 (EP) 03 007 766.3

(51) Int. Cl. C01B 3/00; H05B 6/64

(52) U.S. Cl. 204/157.43; 219/678

(57) ABSTRACT

The invention relates to an apparatus 1 for the flow-through treatment of chemical substances in a microwave field, having a microwave chamber 9, in which microwave radiation acts on the substances, and a flow-through container 12, which extends at least partly in the microwave chamber 9 and in which the substances move in translatory fashion. In order to achieve a simple design while ensuring efficient connections, a device for spirally guiding the substances in the flow-through container 12 is provided.

The invention relates to an apparatus and a method for the microwave treatment of at least one chemical substance in a container.

In the treatment of at least one chemical substance, it is known to subject the chemical substance to a high-frequency field in a treatment chamber of a flow-through container, whereby the chemical substance can be heated.

The purpose of the flow-through treatment may vary. The flow-through treatment may serve, for example, to heat-treat, distil or decompose a solid and/or liquid chemical substance or chemical substance mixture, or initiate and carry out chemical reactions thereon, and/or in the case of a chemical substance mixture to carry out a chemical substance separation.

An apparatus and a method for flow-through treatment are described, for example, in WO 01/72413A1. In the case of the previously known apparatus, a tubular flow-through container extends vertically through a housing enclosing a microwave chamber which surrounds the flow-through container and in which a microwave field can be generated with the aid of a generator. At the upper side and lower side, the free treatment chamber situated in the flow-through container may have an inlet or outlet, which is respectively connected to a feed or discharge line.

In the case of this previously known apparatus, depending on the exposure of the microwave chamber to the microwave field, nonuniform heating may occur, since the microwave chamber is not uniformly exposed to the microwave field and therefore the heating is nonuniform as well.

In order to avoid or at least alleviate this disadvantage, it is known per se to rotate a plurality of containers, distributed about a common axis of rotation and filled with a chemical substance, about the axis of rotation during the exposure to the microwave field. As a result of this rotary movement, the containers with the chemical substance are brought in translatory fashion into different positions in the microwave chamber, whereby the exposure to the microwave field is made uniform.

The object on which the invention is based is to design an apparatus and a method for the flow-through treatment of at least one chemical substance such that a more uniform treatment of the substance is achieved while ensuring a simple and small, in particular narrow, construction.

This object is achieved by the features of claim 1 and 16, respectively. Advantageous developments of the invention are described in the associated subclaims.

In the case of the invention according to claims 1 and 16, provision is made for a device for spirally guiding the substance in the flow-through container which ensures spiral guidance of the substance as it flows through. As a result, the apparatus can be substantially simplified compared with the prior art, since the spiral guidance enables a flow-through movement and simultaneously a translatory movement without the need for a rotary mounting and a drive for the flow-through container, as is known in the case of the prior art. The design according to the invention therefore enables not only a simplification of the construction, but also a small, in particular narrow, construction, since a spiral guide can be realised in a simple construction and requires only a small space, in particular a narrow space. At the same time, a large flow-through capacity can be achieved.

In the case of an apparatus for the flow-through treatment of chemical substances, there is in many cases a requirement to maintain a homogeneous state of the substance. Particularly when a mixture or a plurality of different substances flow through the flow-through container, and are treated, simultaneously, there is the risk of the homogeneity being impaired during the treatment or of the substances segregating or of the homogeneity being inadequate.

The object on which the invention is furthermore based, therefore, is to develop an apparatus and a method for the flow-through treatment of at least one chemical substance such that the homogeneity of the substance is not impaired, and is preferably improved.

It should be noted here that the term “flow through” is to be understood as meaning not only the conveyance of liquids, but also of other media, such as for example solids.

This object is achieved by the features of claim 2 and 17, respectively. Advantageous developments of the invention are described in the associated subclaims.

In the case of the invention according to claims 2 and 17, provision is made for a mixing device for thorough mixing of the substance while it is flowing through the flow-through container. As a result, the homogeneous state of the substance is maintained or improved. The design according to the invention is therefore also suitable for low flow-through rates where there is a particular risk of segregation.

The mixing device and/or spiral guide according to the invention can be formed in a simple and cost-effectively producible manner by a conveyor worm which, owing to the helical or spiral shape, provides spiral guidance for the flow-through substance while constantly changing the direction. This brings about continuous mixing within the substance as it flows through, which not only counteracts segregation but also improves the mixing state. The efficiency is still further improved by the fact that, as it flows through, the substance continuously rubs against the inner wall of the circumferential wall of the flow-through container surrounding the conveyor worm and the mixing action on the substance is thereby increased.

The apparatus according to the invention can be realised in a simple and small and thus cost-effective construction even at a high flow throughput. At the same time, the apparatus can also be realised in a narrow and long or high construction.

It is furthermore advantageous for the flow-through container to protrude from the microwave chamber on one side. In this protruding section, it is possible to realise, independently of the inventive designs according to claim 1 and 2, other advantageous designs, for example an inlet or outlet for the flow-through container which can extend axially or transversely thereto, i.e. radially.

In that region of the flow-through container which protrudes from the microwave chamber, a cooling or heating device for the substance flowing through can be arranged, also with a simple design and advantageous efficiency.

The advantages described with regard to the inventive designs according to claim 1 and 2 also apply correspondingly to the inventive methods according to claims 16 and 17.

Advantageous designs of the invention are explained in more detail below with reference to preferred exemplary embodiments and drawings, in which:

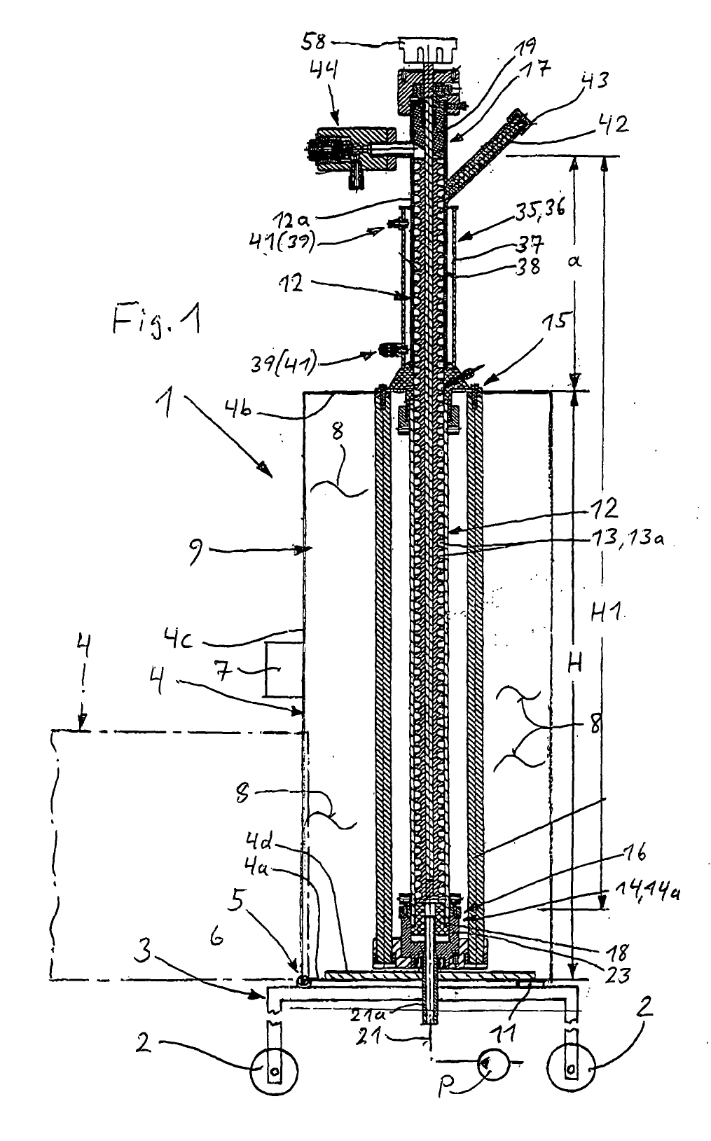

FIG. 1 shows, in vertical section, an apparatus according to the invention for treating a chemical substance in the treatment chamber of a flow-through container;

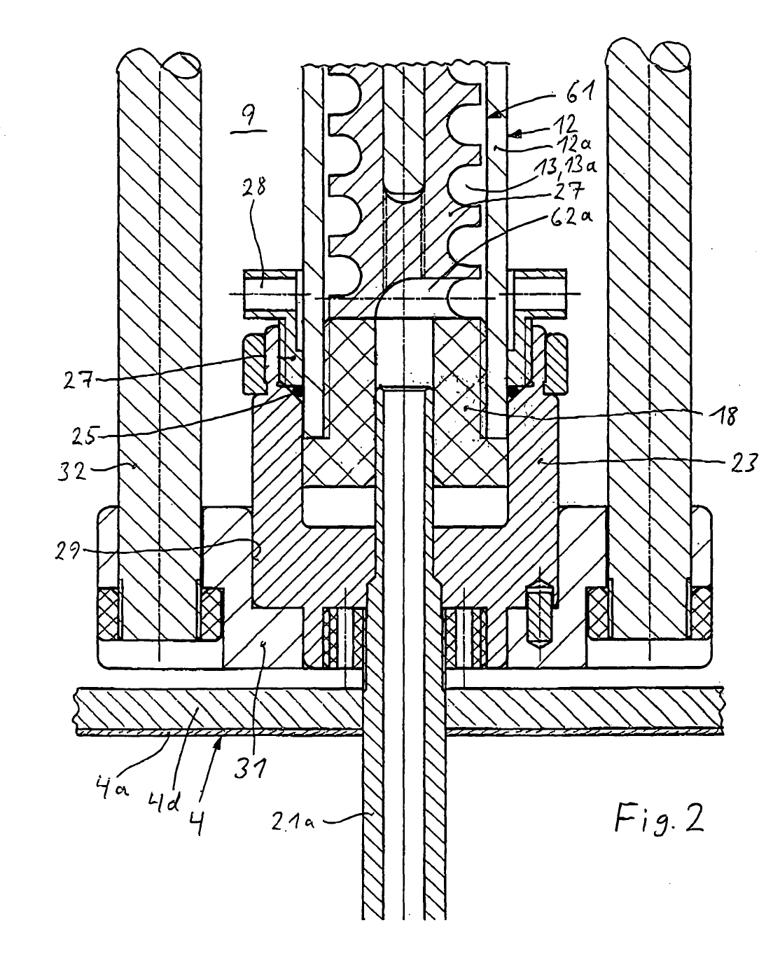

FIG. 2 shows the lower region of the apparatus in an enlarged representation;

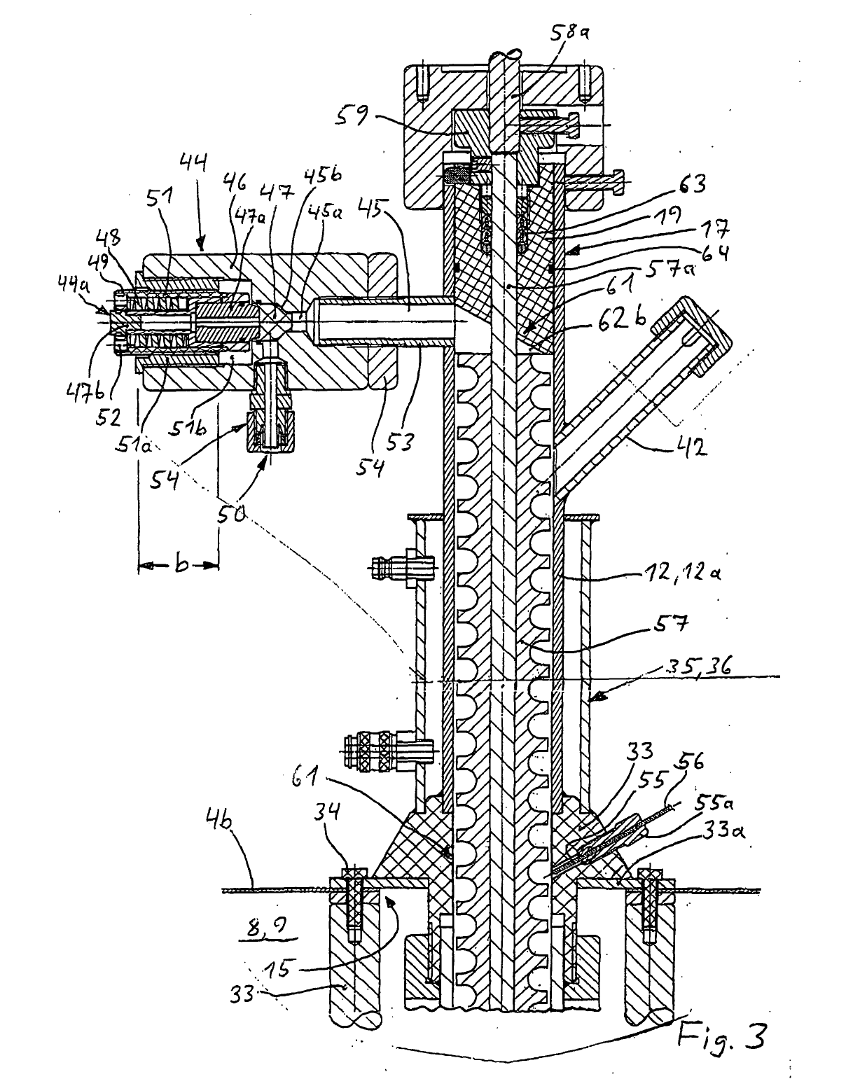

FIG. 3 shows the upper region of the apparatus in an enlarged representation.

The apparatus, denoted in its entirety by 1, is an upright unit which is preferably designed with wheels 2 and has a supporting frame 3, on which is arranged a housing 4 which is round or quadrangular in horizontal cross-section and the horizontal cross-sectional size of which can approximately correspond to or be less than the horizontal cross-sectional size of the supporting frame 3. The housing 4 is pivotably mounted by a joint 5 with a horizontal joint axis, the joint 5 preferably being arranged in the region of one of the two lateral edges of the housing 4. As a result, the apparatus 1 may be pivotable in a vertical pivoting plane from its upright arrangement illustrated into an inclined arrangement or as far as into a horizontal arrangement (merely indicated) and may be lockable in the pivoting end positions or else in optional intermediate positions by a locking device 6, which may, for example, be integrated in the joint 5 or be at a distance therefrom, and makes the joint 5 rigid in the locked state. The supporting frame 3 may, for example, be a framework which is movable on at least two wheels 2 arranged on one side and on the opposite side has a supporting leg, or stands altogether on three or four wheels and is movable.

The housing 4 has a height H which is greater than its horizontal cross-sectional dimension, so that the housing 4 has a columnar shape which may be hollow-cuboid or hollow-cylindrical. The bottom wall, the top wall and the circumferential wall of the housing 4 are denoted by 4a, 4b and 4c. The housing 4 is assigned a generator 7 for generating a high-frequency field 8 in the interior space of the housing 4, which space is thus a microwave chamber 9. The generator 7 may, for example, be arranged laterally on the housing 4. It may be a microwave generator which injects microwaves into the microwave chamber 9 during operation, as is known per se. In the upright or vertical position, the apparatus 1 can be limited by a stop 11 which limits its pivoting movement upwards and abuts against the upper region of the supporting frame 3.

Located in the housing 4, for example in a central position, is a flow-through container 12, in which a receiving chamber 13 for a chemical substance to be treated or to be heated is arranged. The flow-through container 12 is held in the housing 4 by a holding device 14 which is formed, in the case of the exemplary embodiment, from a lower holding-device part 14a in the bottom region of the housing 4 and an upper holding-device part 14b in the upper region of the housing 4.

The flow-through container 12 is of elongate or tubular structural shape and is arranged approximately vertically, and it has a height H1 which is preferably greater than the height H of the housing 4. The flow-through container 12 therefore protrudes from the housing 4. In the case of the exemplary embodiment, it passes through the top wall 4b of the housing 4 in a leadthrough hole 15 and protrudes from the housing 4 upwards, for example by approximately half the height H of the housing 4, so that the height H1 corresponds to approximately 1.5H.

At the lower and upper side, the flow-through container 12 is closed by a closure 16, 17, which may, for example, in each case have a plug 18, 19 which fits into the circumferential wall and seals the latter downwards and upwards, respectively. The plugs or at least the lower plug 18 may have a flange which bears, on the associated side, against the circumferential wall 12a of the flow-through container 12.

The chemical substance to be treated or to be heated may be fed into the receiving chamber 13 in each case through a delivery line which axially passes through the associated plug or inwardly of the plug approximately radially passes through the circumferential wall 12a. In the case of the exemplary embodiment, the delivery line 21 extends into the flow-through container 12 axially from below, in which case it passes through the housing bottom 4a in a leadthrough hole and is inserted into a matching insertion hole in the plug 18.

For additional support and preferably also sealing, the holding-device part 14a has a pot-shaped holding part 23, the pot chamber of which corresponds in a matching manner with play to the outer cross-sectional shape and size of the flow-through container 12, the lower end of the flow-through container 12 being inserted therein and being capable of being sealed by a sealing ring 25. The latter can be elastically compressed between a, for example, conical shoulder surface 26 of the holding part 23 and a bush 27 which is screwed into the holding part 23 and has rotary engagement elements 28 for a rotary tool, in order to ensure sealing even in the case of excess pressures. The holding part 23 preferably has a cylindrical external shape, and it is seated in a stepped recess 29 in the upper side of a clamping ring 31, in which a plurality of, e.g. three, braces 32 distributed uniformly over the circumference are anchored, e.g. screwed, the braces extending upwards as far as the top wall 4b and being screwed to it at the edge of the leadthrough hole 15.

In the region of the top wall 4b, the flow-through container 12 has a flange part 33, the flange 33a of which rests on the edge of the leadthrough hole 15 and is screwed to it by screws 34 which are distributed over the circumference, reach through the flange 33a and the top wall 4b, and are screwed into the braces 32. By this means, the flow-through container 12 is fastened to the top wall 4b and can be mounted from above, the flow-through container section which extends downwards from the flange part 33 being insertable through the leadthrough hole 15 into the housing 4. The holding part 23 and optionally also a connecting pipe 21a of the delivery line 21 may be preassembled parts of the flow-through container 12 and may be mountable with the latter by insertion from above into the housing and demountable again upwards. The connecting pipe 21a reaches through the bottom wall 4a, and a bottom plate 4d fastened thereto, in a leadthrough hole. The flange 33 may replace the circumferential wall 12a and may be present with a and/or lower circumferential-wall section, e.g. by screwing, adhesive bonding or welding.

The apparatus 1 additionally has a cooling or heating device 35 which is arranged in that section a of the flow-through container 12 which protrudes from the housing 4, and is formed, in the case of the exemplary embodiment, by a heat exchanger 36 which surrounds the circumferential wall 12a and to which is fed a cold medium in the case of a cooling device and a hot medium in the case of a heating device. In the case of the exemplary embodiment, the heat exchanger 36 has a heat-exchanger housing 37 which surrounds the circumferential wall 12a at an annular spacing and the interior space 38 of which has in its axial end regions an inlet 39 and an outlet 41 which can be connected to an associated cooling- or heating-medium circuit.

A connecting pipe 42 leads into the upper end region of the receiving chamber 13, here above the cooling or heating device 35, passing through the circumferential wall 12a into the treatment or receiving chamber 13. The connecting pipe 42 may be a lateral inlet or outlet, the opening of which may be optionally closed by a closure, e.g. a screw cap 43. The connecting pipe 42 is suitable, inter alia, for feeding in a further chemical substance, e.g. a substance in small pieces or a powder.

In order to be able to limit a pressure in the receiving chamber 13 during the operation of the apparatus 1, there is assigned to the flow-through container 12 in the upper region a pressure-limiting valve 44 which normally shuts off an outlet channel 45 and opens when the pressure in the receiving chamber 13 exceeds a given value. In the case of the exemplary embodiment, the outlet channel 45 passes through the circumferential wall 12a, and it extends, for example, at an angle into a valve housing 46 in which a closure element 47 is prestressed by a valve spring 48 into its position in which it closes the outlet channel 45. If the pressure is so great that the force produced by it at the closure element 47 exceeds the force of the valve spring 48, the closure element 47 is displaced into its open position, in which the outlet channel 45 is open and the pressure can be released to the outside. The force of the valve spring 48, and thus also the pressure at which the pressure-limiting valve 44 opens, is preferably adjustable. This can be achieved in a simple manner by the abutment 49, on which the valve spring 48 is supported, being adjustable in the longitudinal direction of the valve spring 48 and lockable in the respectively set position. The abutment 49 may be formed by an inner shoulder surface of a threaded sleeve 51, in which the valve spring 48, e.g. a helical spring or at least one disc spring, is arranged. At the rear side, the abutment 49 has at least one tool engagement element 52 for rotary driving of a rotary tool, by means of which it can be either screwed in or out and hence the pressure-limiting valve 44 can be adjusted. The inlet into the valve housing 46 may be formed by a threaded sleeve 53 which passes through the circumferential wall 12a and is fastened thereto, the valve housing 46 being screwed onto the free end of the threaded sleeve 53 and locked by a locknut 54. The outlet 50 of the valve housing 46 is formed by a screw fitting 54, to which can be connected a hose which leads on or a pipe which leads on.

A simple, easy-to-produce and cost-effective construction is achieved when the closure element 47 or a ram 47a which actuates the closure element 47 and is under the force of the spring 48 forms with the threaded sleeve 51 a constructional unit which can be prefabricated and mounted in a simple way and either screwed in or out. In the case of the exemplary embodiment, the threaded sleeve 51 is screwed into a receiving sleeve 51a which, in turn, is firmly screwed into and secured in a corresponding open recess 51b in the valve housing 46, for example by a flange bearing against the valve housing 46. The receiving sleeve 51a may likewise be part of the above-described constructional unit.

It is furthermore advantageous to assign to the pressure-limiting valve 44 a, for example optically visible, indicator 44a which indicates the pressure present in the receiving chamber 13 or indicates an upper limit of this pressure. In the case of the exemplary embodiment, the indicator 44a is formed by a ram extension 47b which extends coaxially through the annular spring 48 and passes with little play through the rear wall, forming the abutment 49, of the threaded sleeve 51. In this case, the end face of the ram extension 47b or a marking on the circumferential surface of the ram extension 47b protruding from the rear wall may form the optical indicator 44a.

In the case of the exemplary embodiment, the closure element 47 is a plug which is arranged coaxially with respect to the first outlet line section 45a and of which the closing surface, preferably designed as a conical surface, bears against a shoulder surface 45b which widens the first outlet line section 45a, is preferably of correspondingly conical design and forms the valve seat.

In order to be able to measure the temperature which arises in the receiving chamber 13 during the operation of the apparatus 1, there is provided a temperature sensor 55 which measures the operating temperature in the receiving chamber 13 and is connected by a signal line 56 to an electrical control device (not illustrated) which can control a signal output corresponding to the temperature or can switch off the generator 7 or regulate its power by reducing or increasing it such that the operating temperature is adjusted to a specific desired value. A preferred location in which to arrange the temperature sensor 54 is the flange part 33, in the region of which there is an increased amount of material for arranging the temperature sensor 55, which is located, for example, in a screw-in cartridge 55a.

Within the context of the invention, the treatment or receiving chamber 13 may be formed by the hollow space of the flow-through container 12 enclosed by the circumferential wall 12a. In such a case, the entire cross-section of the tubular flow-through container 12 is available as the flow-through cross-section. Here, an inlet or outlet may be present in the lower region and in the upper region of the receiving chamber 13 respectively, through which inlet or outlet the chemical substance can flow either from the bottom upwards or from the top downwards. In the case of the exemplary embodiment, the delivery line 21 or the connecting pipe 21a forms an inlet for the flowable chemical substance, it being possible for an outlet, e.g. the outlet 50, arranged in the upper region of the receiving chamber 13 to cooperate with the inlet.

In the case of the exemplary embodiment, there is arranged in the receiving chamber 13 a partition 57 which has a cross-sectional shape adapted with play to the cross-sectional size and to the circular cross-sectional shape of the circumferential wall 12a and in addition has a treatment chamber 13a which is formed by a channel in the partition 57, extends longitudinally right through the partition 57 and thereby forms a flow channel, passing right through longitudinally, for the chemical substance to be treated or to be heated. The treatment chamber 13a is thus part of the receiving chamber 13. The treatment chamber 13a, which only constitutes part of the cross-sectional size of the receiving chamber 13 owing to the presence of the partition 57, is helical, e.g. shaped like a screw thread, in the case of the exemplary embodiment, so that its length is a multiple of the length of the partition 57, which extends from the lower closure 16 as far as the upper closure 17 in the case of the exemplary embodiment. The helical treatment chamber 13a may be formed by a helical groove in the cylindrical circumferential surface of the partition 57, the groove bottom or cross-sectional shape of which may, for example, be of semicircular shape. In the case of such a design, the treatment chamber 13a is bounded on the outside by the inner surface of the circumferential wall 12a. In such a case, the partition 57 is designed like a conveyor worm. The cross-sectional shape of the helical treatment chamber 13a is preferably semicircular.

For reasons still to be explained, it is advantageous to arrange the partition 57 rotatably in the flow-through container 12 and to rotate it using a rotary drive 58 during the operation of the apparatus 1. On rotation, the helical sections of the treatment chamber 13a, which are visible in the transverse view, travel upwards or downwards in the longitudinal direction of the partition 57 depending on the direction of rotation, as is the case with a screw thread.

The design with the partition 57 or the conveyor worm is advantageous for several reasons.

During the operation of the apparatus 1, the chemical substance to be treated is conveyed longitudinally through the flow-through container 12, for example by means of a pump P which is arranged in the delivery line 21 in the case of the exemplary embodiment. Owing to the helical shape of the treatment chamber 13a, the flow path is substantially increased compared with the vertical length and therefore the conveying distance and the residence time of the substance in the region of the microwave chamber 9 are also increased, and particular reactions in the chemical substance can thereby by achieved, for example owing to the longer irradiation, a higher temperature and a higher pressure.

In addition, when the partition 57 is rotated during operation, the treatment chamber 13a, here the helices, is moved in translatory fashion and at the same time in the circumferential direction and transversely thereto, here vertically.

Even with this movement of the treatment chamber 13a in the microwave chamber 9, uniform heating of the chemical substance is obtained, while the chemical substance can in addition be conveyed in the pass-through direction.

The apparatus 1 is suitable, as desired, for one of the two flow-through directions directed along the flow-through container 12. In this regard, the apparatus 1 may be vertically arranged, as shown in FIG. 1 by continuous lines, or it may be arranged in an optional inclined position or horizontally, as merely indicated in FIG. 1 by dot-dash lines. In the vertical or an inclined position, the apparatus 1 is also suitable, with a flowable or pourable substance, for self-acting delivery from the top downwards owing to the force of gravity, both when the conveyor worm is stationary or rotating.

During rotation, when the partition is designed in the form of a conveyor worm, intensive mixing of the chemical substance takes place. This is because the conveyor worm and the circumferential wall 12a of the flow-through container 12 form a mixing device 61. The efficiency of the mixing device 61 is based on the fact that, during the rotation of the partition 57 or the conveyor worm, the chemical substance continuously rubs against the stationary circumferential wall 12a and therefore a continuous circulation of the chemical substance in the treatment chamber 13a takes place. Further thorough mixing takes place at the beginning and the end of the helix of the treatment chamber 13a, namely where the helix is in communication with the radially or axially adjoining flow-through line section by means of a radial free space or channel 62a, 62b, respectively.

The rotary drive 58 arranged at the top in the case of the exemplary embodiment may have a rotary drive pin 58a which is connected in a rotationally fixed manner to a pivot pin 57a of the partition 57. This connection may be formed, for example, by a connecting bush 59, in which both pins engage in a rotationally fixed manner and are secured against rotation by radial locking screws.

Instead of a rotary drive with direct mechanical connection, provision may also be made for a magnetic coupling between the drive and the partition, in the region of which coupling the flow-through container 12 may be closed.

The pivot pin 57a reaches through the associated plug 19 in a coaxial leadthrough hole, the annular gap therebetween being sealed by an annular seal 63. In the case of the exemplary embodiment, the pivot pin 57a is a connecting shaft which reaches through the partition 57 over a large part of its length, is made of sufficiently resistant material, e.g. stainless steel, is connected to the partition 57 and stabilises the partition 57 or the conveyor worm.

The upper plug 19 is preferably likewise sealed by a sealing ring 64, which in the case of the exemplary embodiment is seated in an annular groove of the plug 19 and cooperates sealingly with the inner wall of the circumferential wall 12a.

In the exemplary embodiment, visible in particular from FIG. 3, the pressure-limiting valve 44 is set such that the elastically compliant closure element 47 of the flow-through line is normally closed and only opens when a specific internal pressure builds up in the treatment chamber. As can likewise be seen in FIG. 3 owing to the relatively large displacement travel b of the valve 44, the valve 44 can be opened so far that the flow-through cross-section in the region of the valve seat is continuously open and therefore the treatment of the substance can be effected in a substantially unpressurised manner.

The individual parts of the apparatus 1 are designed such that they do not heat up damagingly under the irradiation of the microwaves. A synthetic material is preferably suitable for this purpose. Certain parts may, however, also be formed from metal, e.g. stainless steel.

1. Apparatus for treating chemical substances in a microwave field, comprising:
a microwave chamber, in which microwave radiation acts on the substances,
a container, which extends at least partly in the microwave chamber, for receiving the substances to be treated, and
a device for spirally transporting the substances in the container.

2. Apparatus for treating chemical substances in a microwave field, comprising:
a microwave chamber, in which microwave radiation acts on the substances,
a flow-through container, which extends at least partly in the microwave chamber, for receiving the substances, and
a mixing device for thorough mixing of the substances while they are being transported in the axial direction through the flow-through container.

3. Apparatus according to claim 1 wherein the spiral device comprises a conveyor worm.

4. Apparatus according to claim 3, wherein the conveyor worm comprises a rotary drive to effect forced conveyance of the substances in the flow-through container.

5. Apparatus according to claim 3, wherein the flow-through container is a hollow cylinder and the conveyor worm is arranged with little play in the flow-through container.

6. Apparatus according to claim 1, wherein a longitudinal dimension, extending in the microwave chamber, of the flow-through container and of the spiral guide is a multiple of an inner cross-sectional dimension of the flow-through container.

7. Apparatus according to claim 1, wherein said apparatus is arranged vertically or such that it can be inclined and locked in an inclined position.

8. Apparatus according to claim 1, wherein the flow-through container is connected at respective ends to an axial or radial flow-through line section, respectively.

9. Apparatus according to claim 8, wherein the axial flow-through line section passes through a housing wall bounding the microwave space.

10. Apparatus according to claim 1, wherein the flow-through container protrudes from the microwave chamber.

11. Apparatus according to claim 10, wherein an inlet or outlet for the flow-through container is arranged in the protruding end region of the flow-through container.

12. Apparatus according to claim 1, wherein a treatment chamber is defined in the flow-through container and is connected to a pressure-limiting valve.

13. Apparatus according to claim 12, wherein the pressure-limiting valve is arranged in a flow-through line section.

14. Apparatus according to claim 10, wherein a cooling or heating device is arranged in a region of the flow-through container which protrudes from the microwave chamber.

15. Apparatus according to claim 10, wherein a connecting piece is arranged in a region of the flow-through container which protrudes from the microwave chamber.

16. Method for treating chemical substances in a microwave field, comprising the steps of
providing microwave radiation acting on the substances in a microwave chamber,
moving the substances in translatory fashion in a container which extends at least partly in the microwave chamber, and
further actively moving the substances in the container in a direction transversely to the direction of translation.

17. Method for treating chemical substances in a microwave field, comprising the steps of
providing microwave radiation on the substances in a microwave chamber,
moving the substances in a container which extends at least partly in the microwave chamber, and
further actively mixing the substances in the container by a mixing device.

18. Apparatus according to claim 6, wherein said longitudinal dimension is at least five times said inner cross-sectional dimension.

19. Apparatus according to claim 6, wherein said longitudinal dimension is at least ten times said inner cross-sectional dimension.

20. Apparatus according to claim 9, wherein the housing wall is horizontal.

21. Apparatus according to claim 10, wherein the spiral device protrudes from the microwave chamber.

22. Apparatus according to claim 12, wherein the pressure-limiting valve is adjustable.

23. Apparatus according to claim 13, wherein the pressure limiting valve is arranged in an outlet line section.

24. Apparatus according to claim 13, wherein the pressure-limiting valve is displaceable so far that in an open position it frees the flow-through line.

25. Apparatus according to claim 2 wherein the mixing device is a conveyor worm.

26. Apparatus according to claim 25, wherein the conveyor worm comprises a rotary drive to effect forced conveyance of the substances in the flow-through container.

27. Apparatus according to claim 25, wherein the flow-through container is a hollow cylinder and the conveyor worm is arranged with little play in the flow-through container.

28. Apparatus according to claim 2, wherein a longitudinal dimension, extending in the microwave chamber, of the flow-through container and of the spiral guide is a multiple of an inner cross-sectional dimension of the flow-through container.

29. Apparatus according to claim 28, wherein said longitudinal dimension is at least five times said inner cross-sectional dimension.

30. Apparatus according to claim 28, wherein said longitudinal dimension is at least ten times said inner cross-sectional dimension.

31. Apparatus according to claim 2, wherein said apparatus is arranged vertically or such that it can be inclined and locked in an inclined position.

32. Apparatus according to claim 2, wherein the flow-through container is connected at respective ends to an axial or radial flow-through line section, respectively.

33. Apparatus according to claim 32, wherein the axial flow-through line section passes through a housing wall bounding the microwave space.

34. Apparatus according to claim 33, wherein the housing wall is horizontal.

35. Apparatus according to claim 2, wherein the flow-through container protrudes from the microwave chamber.

36. Apparatus according to claim 35, wherein the mixing device protrudes from the microwave chamber.

37. Apparatus according to claim 35, wherein an inlet or outlet for the flow-through container is arranged in the protruding end region of the flow-through container.

38. Apparatus according to claim 2, wherein a treatment chamber is defined in the flow-through container and is connected to a pressure-limiting valve.

39. Apparatus according to claim 38, wherein the pressure-limiting valve is adjustable.

40. Apparatus according to claim 38, wherein the pressure-limiting valve is arranged in a flow-through line section.

41. Apparatus according to claim 40, wherein the pressure limiting valve is arranged in an outlet line section.

42. Apparatus according to claim 40, wherein the pressure-limiting valve is displaceable so far that in an open position it frees the flow-through line.

43. Apparatus according to claim 35, wherein a cooling or heating device is arranged in that region of the flow-through container which protrudes from the microwave chamber.

44. Apparatus according to claim 35, wherein a connecting piece is arranged in that region of the flow-through container which protrudes from the microwave chamber.
